(19) United States
(12) Patent Application Publication
(10) Pub. No.: US 2018/0020274 A1
(43) Pub. Date: Jan. 18, 2018

(54) Speaker Module

(71) Applicants: Fuhu Zhang, Shenzhen (CN); Shang Gao, Shenzhen (CN)

(72) Inventors: Fuhu Zhang, Shenzhen (CN); Shang Gao, Shenzhen (CN)

(73) Assignee: AAC Technologies Pte. Ltd., Singapore city (SG)

(21) Appl. No.: 15/403,473

(22) Filed: Jan. 11, 2017

(30) Foreign Application Priority Data
Jul. 18, 2016 (CN) 201610564267.2

(51) Int. Cl. H04R 1/02

(52) U.S. Cl. CPC H04R 1/025; H04R 2499/11

(57) ABSTRACT

A speaker module includes a frame; a miniature speaker fixed in the frame and comprising a membrane; and an inner wall arranged in the frame for forming an accommodation space for accommodating the miniature speaker therein. The inner wall further includes at least one projecting part. The inner wall includes a flat part on which no projecting part is arranged; and the projecting part abuts against an outer edge of the membrane of the miniature speaker.

### FIELD OF THE INVENTION

The invention is related to electro-acoustic transducers, more particularly to a miniature speaker used in a portable consumer device.

### DESCRIPTION OF RELATED ART

With the coming of mobile internet times, the quantity of intelligent mobile device is rising continuously. Among many mobile equipment, mobile phone is the most common and portable mobile terminal equipment. At present, the function of mobile phone is diversified. One of important functions is that of high quality music, and the miniature speaker in mobile phone is one of the essential conditions of realizing the function of high quality music.

In relevant technology, a speaker unit is installed in a frame by glue, and a membrane of the speaker unit includes a spare part frequently in the existing miniature speaker, which would be difficult to implement installation because the spare part abuts against a right-angle inner wall on the frame directly when installing the speaker unit on the frame. Accordingly, the performance and the reliability of the speaker unit may be affected because the glue may overflow into the suspension part on the miniature speaker due to such a design.

Therefore, it is necessary to provide an improved miniature speaker to overcome above disadvantage.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a miniature speaker in accordance with an exemplary embodiment of the present disclosure.

FIG. 2 is a partially exploded view of the miniature speaker in FIG. 1.

FIG. 3 is an exploded view of the miniature speaker in FIG. 1.

FIG. 4 is similar to FIG. 3, but from another aspect.

FIG. 5 is an enlarged view of a circled part of FIG. 2.

### DETAILED DESCRIPTION OF THE EXEMPLARY EMBODIMENT

The present invention will hereinafter be described in detail with reference to an exemplary embodiment. To make the technical problems to be solved, technical solutions and beneficial effects of the present disclosure more apparent, the present disclosure is described in further detail together with the figures and the embodiment. It should be understood the specific embodiment described hereby is only to explain this disclosure, not intended to limit this disclosure.

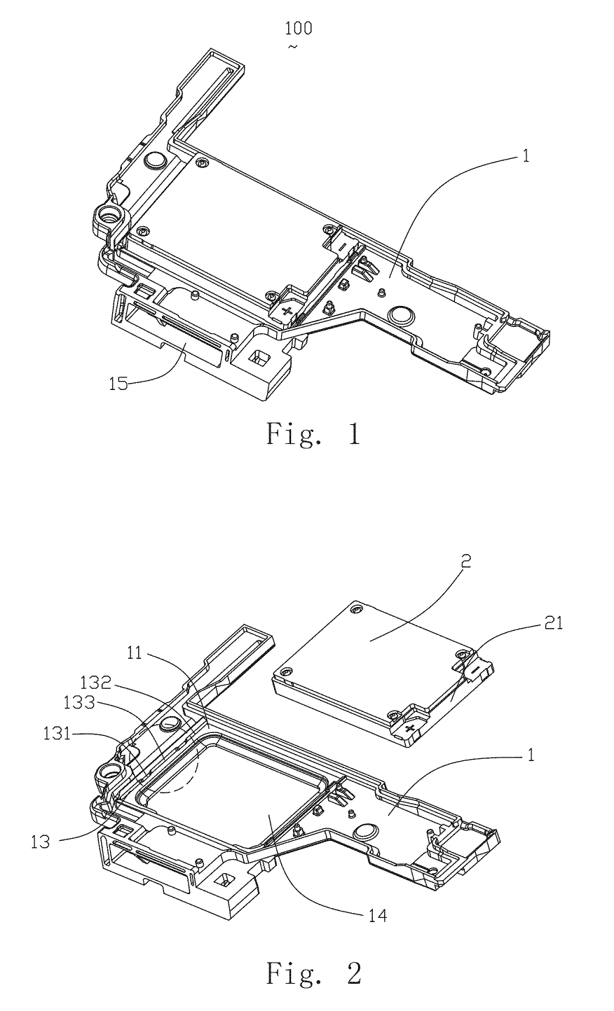

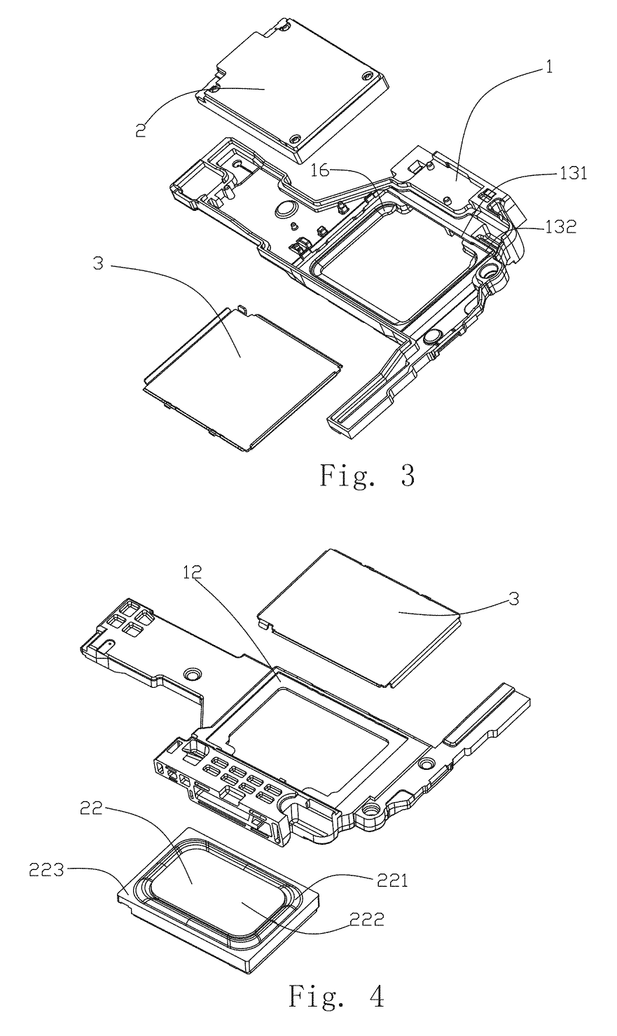

As shown in FIGS. 1-4, a speaker module 100 disclosed in the invention comprises a frame 1, a miniature speaker 2 fixed in the frame 1 and an upper cover 3 arranged on one side of the frame 1.

The frame 1 comprises an upper surface 11, a lower surface 12 opposite to the upper surface 11, an inner wall 13 arranged in the frame 1 for forming an accommodation space 14 for accommodating the miniature speaker 2. The accommodation space 14 extends from the upper surface 11 of the frame 1 and goes through the lower surface 12 of the frame 1.

In this embodiment, the inner wall 13 of the frame 1 is formed by four surfaces connected; therefore, the accommodation space 14 is presented as a rectangle. A projecting part 131 is arranged on at least one of the four surfaces. Optionally, the inner wall can also be an arc surface by which the cylindrical miniature speaker can be accommodated in the accommodation space. The projecting parts 131 are arranged on three surfaces of the inner wall 13, wherein two surfaces are provided with two projecting parts 131.

Alternatively, one or multiple projecting parts 131 can be arranged on any surfaces of the inner wall 13 in accordance with need. The projecting parts 131 on the inner wall 13 are formed by one part of the inner wall on this surface extending toward the inner part of the accommodation space 14, that is, the projecting parts 131 and the frame 1 are formed integrally; and the projecting parts 131 can be formed separately and installed on the inner wall 13 of the frame 1.

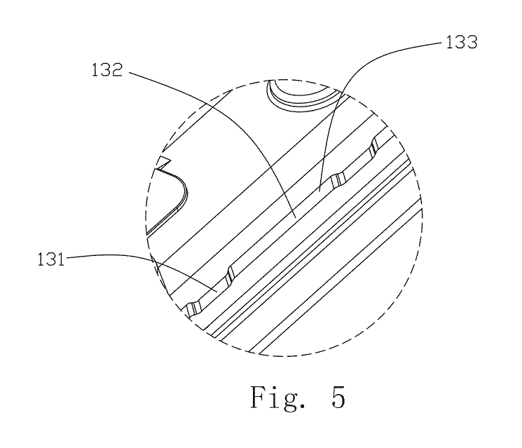

As shown in FIG. 5, the inner wall 13 comprises a flat part 132 on which no projecting part 131 is arranged; the miniature speaker 2 is fixed with the frame 1; a glue accommodating slot 133 for accommodating the excessive glue is formed by the projecting part 131 on the inner wall and the flat part 132. The surface of the projecting part 131 connecting with the flat part 132, therefore, the projecting part 131 is presented as a trapezoid approximately, and the glue can flow into the glue accommodating slot 133. A side wall of the frame 1 is provided with a sound hole communicating with the accommodation space 14; thus, the sound from the miniature speaker 2 can be given out from the side of the frame 1. In addition, the frame 1 also comprises an extending part 16 formed by extending toward the accommodation space 14 from the inner wall 13.

The miniature speaker 2 is accommodated in the accommodation space 14 of the frame 1 and is fixed with the inner wall 13 of the frame 1. The miniature speaker 2 comprises a housing 21 and a membrane 22 arranged on the housing 21. The projecting part 131 of the inner wall 13 of the frame 1 abuts against the edge of the membrane 22 of the miniature speaker 2 in the extending direction of the membrane 22. The extending direction of the sound hole 15 is vertical to the vibrating direction of the membrane 22. The membrane 22 comprises a suspension part 221, a dome 222 arranged at inner side of the suspension part 221 and a fixation part 223 arranged at the periphery of the suspension part 221.

The suspension part 221 of one part of the membrane 22 is covered by the extending part 16 on the frame 1. The spare diaphragm shall be reserved inevitably on the edge of the fixation part 223 during actual fabrication of the membrane; therefore, it would be difficult to install the miniature speaker. In this invention, the edge of the fixation part 223 of the membrane 22 and one part of the housing 21 are abutted to the projecting part 131 on the frame 1 when the miniature speaker 2 is installed on the frame 1; in terms of the spare diaphragm at the edge of the fixation part 223, a little spare diaphragm at the location corresponding to the projecting part 141 shall be in contact with the frame 1 only, while the rest may be positioned at the place of the glue accommodating slot 133 and would not be in touch with the frame 1 in the suspended state. Therefore, certain pressure can be reduced when the miniature speaker 2 is installed on the frame 1; and the miniature speaker 2 can be installed conveniently after being pressed inward manually, without other auxiliary equipment.

The upper cover 3 is installed to the lower surface 12 of the frame 1 when the miniature speaker 2 is installed in order to cover the membrane 22 on the miniature speaker; and the upper cover 3 is fixed with the frame 1 by means of ultrasonic welding technology.

A little spare diaphragm of the membrane is abutted to the projecting part 131 only because the projecting part 131 is arranged on the inner wall 13 of the accommodation space 14 of the frame 1 in the speaker module 100 of the invention; therefore, miniature speaker can be installed conveniently and the installation reliably can be improved. At the same time, the speaker module 100 is ensured to have excellent performance because the glue accommodating slot 133 formed between the projecting part 131 and the inner wall can accommodate the excessive glue in order to prevent the glue from overflowing onto the suspension part 221 of the membrane 22.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

1. A speaker module including:
a frame;
a miniature speaker fixed in the frame and comprising a membrane;
an inner wall arranged in the frame for forming an accommodation space for accommodating the miniature speaker therein, the inner wall further including at least one projecting part; wherein
the inner wall comprises a flat part on which no projecting part is arranged;
the projecting part extends toward the accommodation space from the inner wall;
a glue accommodating slot is formed in the projecting part on the inner wall and the flat part;
a surface of the projecting part connecting with the flat part is a slope;
and the projecting part abuts against an outer edge of the membrane of the miniature speaker.

2-4. (canceled)

5. The speaker module as described in claim 1 further comprising an upper cover for covering the miniature speaker.

6. The speaker module as described in claim 5, wherein the upper cover and the frame are fixed together by means of ultrasonic welding.

7. The speaker module as described in claim 1, wherein a side wall of the frame is provided with a sound hole communicating with the accommodation space; and an extending direction of the sound hole is vertical to the vibrating direction of the membrane.

8. The speaker module as described in claim 1, wherein the inner wall of the frame is formed by four surfaces connected, and at least one projecting part is arranged on at least one of the four surfaces.
